(19) United States
(12) Patent Application Publication
(10) Pub. No.: US 2010/0224107 A1
(43) Pub. Date: Sep. 9, 2010

(54) TABLE HAVING FOLDING LEGS

(75) Inventors: Darren ALDRED, Morristown, TN (US); Stephen HODGES, Russelville, TN (US); Stephen J. ZWONITZER, Atlanta, GA (US)

Correspondence Address: MCGUIREWOODS, LLP, 1750 TYSONS BLVD, SUITE 1800, MCLEAN, VA, 22102, US

(73) Assignee: Meco Corporation, Greenville, TN (US)

(21) Appl. No.: 12/534,992

(22) Filed: Aug. 4, 2009

Related U.S. Application Data
(60) Provisional application No. 61/157,939, filed on Mar. 6, 2009.

(51) Int. Cl. A47B 3/08; A47B 3/00; B23P 11/00

(52) U.S. Cl. 108/129; 29/428

(57) ABSTRACT

The invention is directed to a table being configured to be arranged in a compact arrangement and being configured to be arranged in an arrangement for use. The table including a table top having a top surface and a bottom surface, a plurality of legs that are arranged below the bottom surface and connected to the bottom surface to support the table top above a floor, a swivel connection that connects the plurality of legs together in a swiveling manner, and a pivotal connection that pivotally connects the plurality of legs to one of the bottom surface.

### CROSS REFERENCES TO PRIOR APPLICATIONS

This application claims priority and the benefit thereof under 35 U.S.C. §119(e) from U.S. Provisional Application No. 61/157,939, filed on Mar. 6, 2009, which is hereby incorporated by reference for all purposes as if fully set forth herein.

### BACKGROUND OF THE INVENTION

1. Field of the Invention

The invention is directed generally to a table that has folding legs and, more particularly, to a table that has folding legs that swivel and fold to achieve a compact configuration.

2. Related Art

Many tables are designed to be rearranged into a compact configuration in order to be transported or stored. Such tables have legs that individually fold under the table. However, many of these tables have drawbacks, such as the legs of the tables are often unattractive, difficult to fold into a compact arrangement, and/or are not sturdy. Consumers may avoid these types of tables due to these drawbacks and purchase tables that are not able to be configured into a compact configuration. The results are a more attractive table, but a table that is unable to be configured into a compact arrangement for storage and transport. Accordingly, there is a need for a table that is both attractive and sturdy yet can also be arranged and configured into a compact configuration for transport and storage.

### SUMMARY OF THE INVENTION

The invention meets the foregoing need and provides a table that is attractive and that may be arranged easily into a compact arrangement. Additionally, the invention provides a table that is sturdy and that includes other advantages apparent from the discussion herein.

The invention may be implemented in a number of ways. According to one aspect of the invention a table is configured to be arranged in a compact arrangement and is configured to be arranged in an arrangement for use includes a table top having a top surface and a bottom surface, a plurality of legs that are arranged below the bottom surface and connected to the bottom surface to support the table top above a floor, a swivel connector that connects the plurality of legs together in a swiveling manner, and a pivotal connection, including a pivotal connector and pivotal fastener, that pivotally connects the plurality of legs to one of the bottom surface.

According to one aspect of the invention, a reconfigurable table is provided that includes a table top having a top surface and a bottom surface. The table comprises: a plurality of legs configured to support the table top, wherein the plurality of legs comprises a swivel leg and a pivoting leg; a swivel connector configured to connect the swivel leg to the pivoting leg, wherein the swivel connector is further configured to allow the swivel leg to swivel with respect to the pivoting leg; and a pivotal connector configured to pivotally connect the pivoting leg to the bottom surface, wherein the swivel leg is only connected to the swivel connector when the plurality of legs are arranged in a compact configuration.

According to a further aspect of the invention, a reconfigurable table is provided that includes a table top having a top surface and a bottom surface, the table comprising: a plurality of legs configured to support the table top, wherein the plurality of legs comprises a swivel leg and a pivoting leg; a swivel connector configured to connect the plurality of legs to each other along a first axis, wherein the swivel connector is further configured to allow at least one of the plurality of legs to rotate in a plane substantially perpendicular to the first axis; and a pivotal connector configured to pivotally connect the pivoting leg to the bottom surface. At least one of the plurality of legs may comprise a curved shape that is configured to extend from an upper end at an outer edge of the bottom surface inwardly to the swivel connector and extend outwardly from the swivel connector to a floor. The table may further comprise a table frame portion attached to the bottom surface. The table frame portion may be configured to be coupled to the pivotal connector. The swivel leg may be configured to swivel with respect to the pivoting leg. The swivel leg may be positioned substantially opposite the pivoting leg when the plurality of legs is arranged in an operative configuration. The table may further comprise a coupler configured to receive a portion of the swivel leg. The coupler may comprise a locking ramp configured to receive the portion of the swivel leg. The coupler may further comprise: an elastic member configured to move in response to a predetermined force; a seat portion configured to receive the portion of the swivel leg; and a stop configured hold the portion of the swivel leg in the seat portion. The pivotal connector may comprise a post configured to be inserted into the table frame portion. The post may be arranged on an end portion of the pivoting leg. The table may further comprise a pivotal fastener configured to attach another pivoting leg to the bottom surface. The pivotal fastener may comprise a bolt and nut combination. The table may further comprise a lock configured to hold at least one of the plurality of legs in a position substantially parallel to the bottom surface. The lock may comprise a hook and loop mechanism secured to the bottom surface.

According to a further aspect of the invention, a method is provided for configuring a reconfigurable table that includes a table top having a top surface and a bottom surface. The method comprises: coupling a pivoting leg to the bottom surface; affixing another pivoting leg to the bottom surface; and attaching the pivoting legs to each other, wherein the pivoting legs pivot substantially simultaneously with respect to the bottom surface. The method may further comprise attaching opposing swivel legs to the pivoting legs, wherein the opposing swivel legs swivel with respect to the pivoting legs. The coupling the pivoting leg to the bottom surface may comprise inserting a post into a table frame portion. The affixing the another pivoting leg may comprise attaching the another pivoting leg to a table frame portion with a bolt and nut combination. The method may further comprise attaching a lock to the bottom surface, wherein the lock is configured to hold at least one of the pivoting legs and swivel legs.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a perspective view of a table constructed according to the principles of the invention;

FIG. 2A shows an example of a perspective bottom-side view of the table and legs constructed according to the principles of the invention;

FIG. 2B shows exploded “Before” and “After” views of a portion of the bottom of the table shown in FIG. 2A, where a pivoting leg attaches to a table frame portion, according to the principles of the invention;

FIG. 3A shows an exploded view of another portion of the bottom of the table shown in FIG. 2A before another pivoting leg attaches to another table frame portion;

FIG. 3B shows an exploded view of the portion of the bottom of the table shown in FIG. 3A after the other pivoting leg attaches to the other table frame portion;

FIG. 4 shows a perspective bottom-side view of the table with the legs arranged together and folded into a compact configuration;

FIG. 5 shows a bottom side view of the table with the legs in the extended configuration, but not yet fully arranged in the operative configuration;

FIG. 6 shows the movement of the legs of the table to the operative configuration;

FIG. 7A shows an example of a perspective bottom-side view of the table in an operative configuration, with the swivel legs coupled to couplers, according to the principles of the invention;

FIG. 7B shows an exploded view of an end portion of a swivel leg coupled to a coupler, according to the principles of the invention;

FIG. 8 shows a perspective side view of an example of a coupler, according to the principles of the invention;

FIG. 9 shows a perspective bottom-side view of the table with the legs arranged in a compact and locked configuration, according to the principles of the invention;

FIG. 10A shows a flow diagram of an example of a process for assembling and affixing a plurality of legs to a table bottom and moving the legs to an operative configuration, according the principles of the invention; and

FIG. 10B shows a flow diagram of an example of a process for releasing and configuring the table into a compact configuration, including a locking configuration, according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

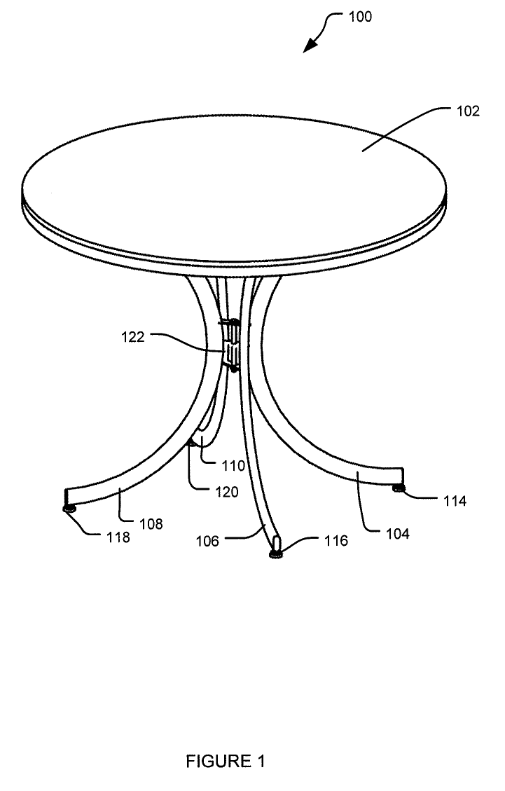

FIG. 1 shows a perspective view of an example of a table constructed according to the principles of the invention. In particular, FIG. 1 shows a table 100 that may include a table top 102 and legs 104, 106, 108, 110 to support the same. The table top 102 may include any shape, including, for example, but not limited to, a circle shape, a square shape, a rectangle shape, an oval shape, or the like. Although four legs are shown in the Figures, any number of legs (greater than two) are contemplated by the invention. The legs are connected to one another through a swivel connector 122. The legs 104, 106, 108, 110 may also optionally include feet 114, 116, 118, 120 to support the legs 104, 106, 108, 110 on the floor.

The legs 104, 106, 108, 110 may be constructed to rotate or swivel as a pair about a central axis of the swivel connector 122. The legs may also fold about a pivot point 151, 153 under the table top 102. The combination of swiveling of the two legs 106, 110 with respect to the other two legs 104, 108, and/or the paired construction of the legs provides, in part, a compact and strong arrangement of legs. The swivel connector 122 may be configured to allow the legs 104, 106, 108, 110 to swivel as pairs with respect to each other to form a flat arrangement. The table 100 may further include a pivoting structure between the legs 104, 106, 108, 110 and the table top 102 to further allow the legs to fold or rotate flat with respect to the table 100 as described in further detail below. In this regard, the swiveling of the legs 104, 106, 108, 110 and the subsequent pivoting of the legs with respective table top 102 provides a table 100 that is attractive, sturdy and is configured to be rearrangeable to a compact configuration for storage and transport.

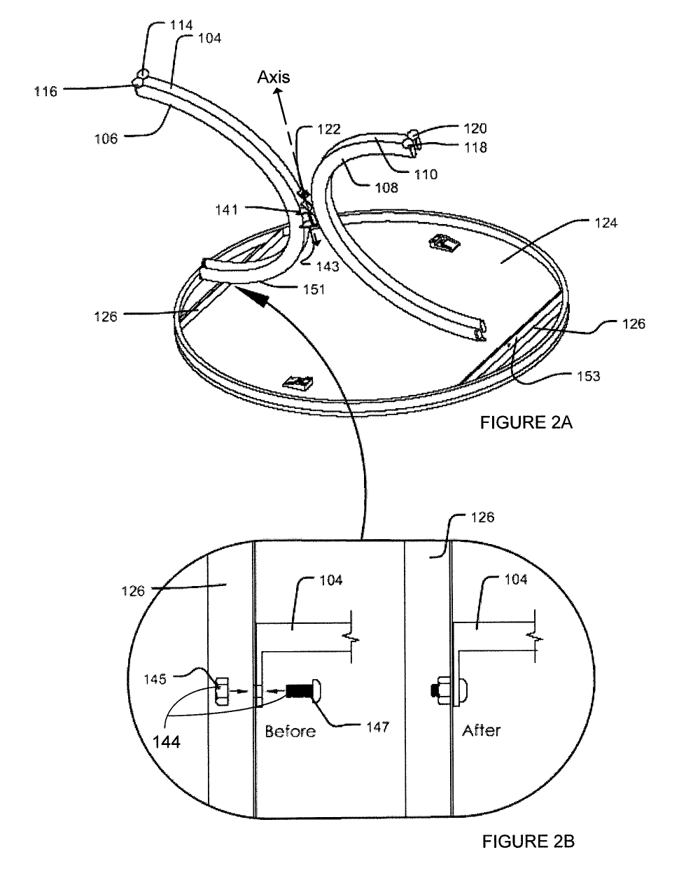

FIG. 2A shows an example of a perspective bottom-side view of the table bottom surface 124 and legs 104, 106, 108, 110, constructed according to the principles of the invention. The legs 104, 106, 108, 110 may be connected to each other via the swivel connector 122. The swivel connector 122 may include any structure that structurally and rigidly connects the legs 104, 106, 108, 110 along a central axis (“Axis”), while permitting rotation (or movement) of some or all of the legs in a plane substantially perpendicular to the central axis (or one or more axes offset from the central axis). The swivel connector 122 may include, for example, but is in no way limited to, a pin (or bolt) 141 that connects engageable leg extension members 143 on each of the legs 104, 106, 108,110 to allow rotation (or pivoting) of the leg extension members 143 individually or as paired groupings about the longitudinal axis of the pin 141, which may include the central axis of the swivel connector 122. The extension members 143 may be unique to each leg 104, 106, 108, 110, or shared as a unitary structure by opposing leg pairs 104, 108 and 106, 110. For instance, the swivel connector 122 may be configured to include an individual leg extension member 143 for each of the legs 104, 106, 108, 110, wherein all four members 143 are connected to each other by the pin 141, so that each leg 104, 106, 108, 110 may individually and separately move (swivel or rotate) about the central axis of the swivel connector 122.

Alternatively, the swivel connector 122 may be configured to fixedly hold opposed leg pairs 104, 108 and 106, 110, so that each leg pair (104, 108) may be rotatably movable with regard to the other leg pair (106, 110) about the central axis (or one or more axes offset from the central axis) of the swivel connector 122. In this regard, opposite legs may be paired and joined by a common extension member 143, so that the joined leg pairs are simultaneously movable about the central axis of the swivel connector 122.

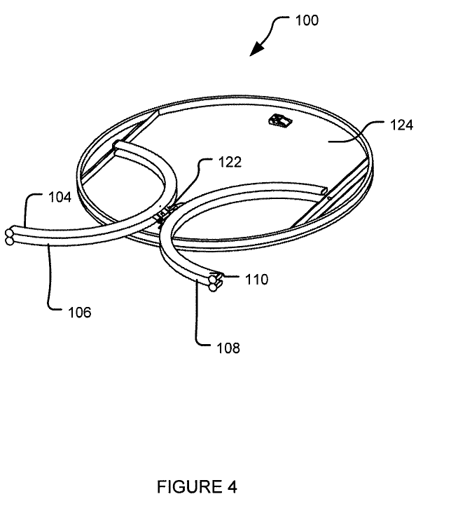

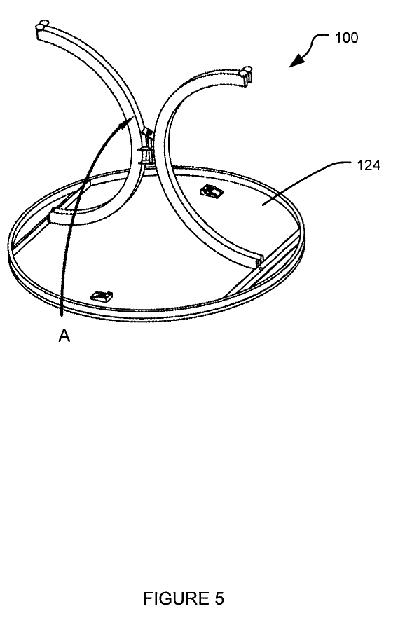

As seen in FIG. 2A, at least two of the legs 104, 108 (pivoting legs) may be pivotally connected to table frame portions 126, at pivot points 151, 153, respectively. The leg 104 may be pivotally connected to the table frame portion 126 at pivot point 151 and the leg 108 may be pivotally connected to the table frame portion 126 at the pivot point 153. Accordingly, the entire grouping of legs 104, 106, 108, 110, may be pivoted with respect to these pivot points 151, 153, and the table frame portions 126 to move from an extended configuration (position) (shown in FIG. 5) to a compacted configuration (position) that is rotated flat and substantially parallel with the table bottom 124 (shown in FIG. 4).

FIG. 2B shows exploded “Before” and “After” views of the portion of the bottom side of the table 100 shown in FIG. 2A, according to the principles of the invention. The leg 104 may be pivotally connected to the table frame portion 126 using a pivotal fastener 144, such as, for example, but not limited to a nut 145 and a bolt 147. It is noted that the opposite leg 108 may be similarly connected to the table frame portion 126. Of course other types of connections and/or mechanical fasteners are within the spirit and scope of the invention.

Although the table frame portions 126 are shown in FIGS. 2A, 2B as L-shaped longitudinal members, it is noted that one (or both) table frame portions 126 may include a slide-track member (not shown) configured to slideably engage or pair with the legs 104, 108, so as to allow one (or both) legs 104, 108 to move along a longitudinal direction of the slide-track member. It is noted that any other structure may be used for the table frame portions 126 that permits pivoting movement of the legs 104, 108, with regard to the table bottom 124, without departing from the scope or spirit of the invention.

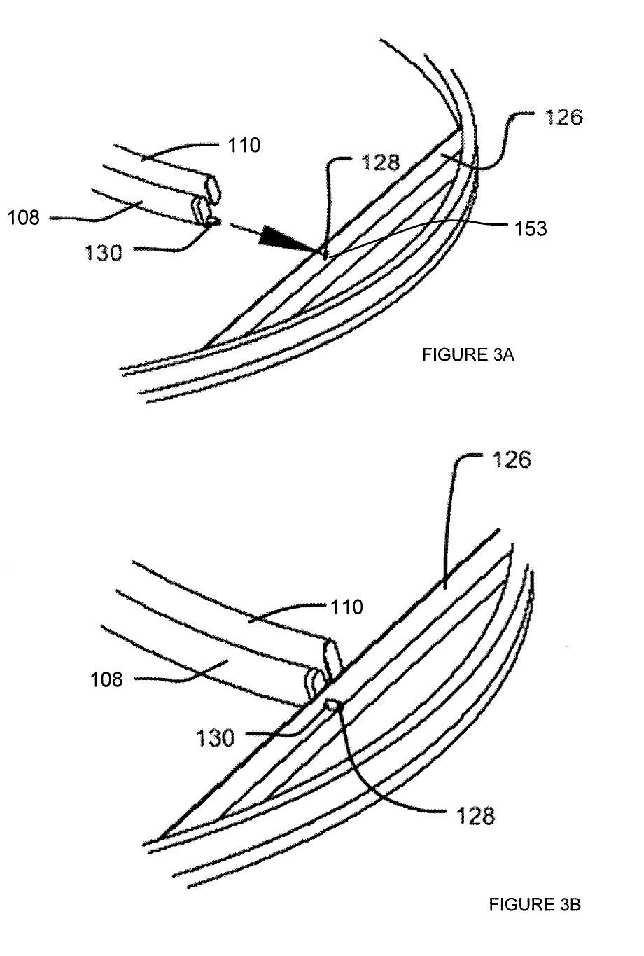

FIG. 3A shows an exploded view of a portion of the bottom side of the table 100 before the pivoting leg 108 attaches to the table frame portion 126. The leg 108 may include a pivotal connector 130. The pivotal connector 130 may include, for example, but is not limited to, a post, a pin, a nub, a bolt-nut combination, or the like. The table frame portion 126 may include a hole 128 located at the pivot point 153. The leg 108 may be connected to the table frame portion 126 by inserting the pivotal connector 130 into the hole 128. It is noted that the opposite leg 104 may be similarly connected to the table frame portion 126. Together with the connection of the leg 104 to the table frame portion 126 (shown in FIGS. 2A, 2B), the connection of the leg 108 to the table frame portion 126 forms a strong pivotal connection of legs 104,108 to the table 100.

In the case where the pivoting legs 104, 108 are rigidly paired to each other (i.e., pivoting leg 104 is fixed to pivoting leg 108 by means of a common extension member 143), and the swivel legs 106,110 are rigidly paired to each other (i.e., swivel leg 106 is fixed to swivel leg 110 by means of another common extension member 143), the swivel leg pair 106, 110 may be swiveled (or rotated) simultaneously about the central axis of the swivel connector 122 to collapse the legs 106, 110, so that leg 106 is substantially adjacent to leg 104 and leg 110 is substantially adjacent to leg 108, as seen in FIG. 2A.

FIG. 3B shows an exploded view of the portion of the bottom side of the table 100 shown in FIG. 3A after the leg 108 attaches to the table frame portion 126.

Although the pivotal connector 130 is shown in FIGS. 3A, 3B as being located on the leg 108, and the hole 128 is shown as being located in the table frame portion 126, an alternative arrangement may be equally implemented. For example, the pivotal connector 130 may be provided on the table frame portion 126 and the hole 128 may be provided in an end portion of the leg 108. In this embodiment of the invention, the leg 108 may be mounted to the pivotal connector 130 located on the table frame portion 126.

FIG. 4 shows an example of a bottom side view of the table 100 with the legs 104, 106, 108, 110 swiveled together and folded into a compact configuration, according to the principles of the invention.

FIG. 5 shows an example of a bottom side view of the table 100 with the legs 104, 106, 108, 110 swiveled to an extended configuration, but not yet fully arranged in an operative configuration. A direction arrow A shows an example of the pivot direction of the legs 104, 106, 108, 110, which may be moved as a group (along direction A) from the compacted configuration—i.e., substantially parallel to the bottom surface 124—to the extended configuration—i.e., substantially normal or perpendicular to the bottom surface 124.

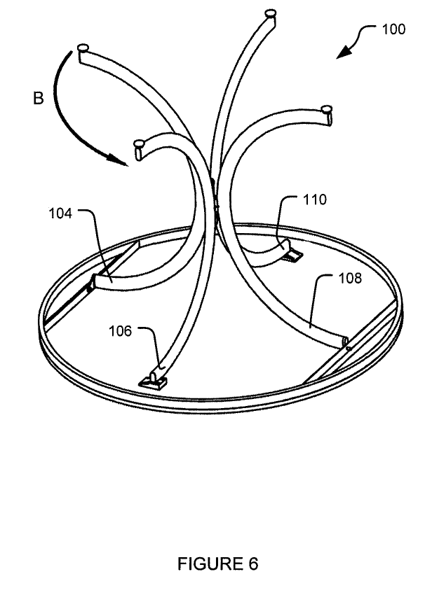

FIG. 6 shows an example of a bottom side view of the table 100 with legs 104, 106, 108, 110, swiveled and arranged in an operative configuration. A direction arrow B shows an example of a swivel (or rotation) movement of the leg 106 as the leg is moved from the extended configuration to the operative configuration, for example, as a result of a force applied to the leg 106. Simultaneously, the leg 110 may be moved along the same direction B by components of the same force being conveyed from the leg 106 (through the swivel connector 122) to the leg 110.

In the alternative embodiment, where the legs 106, 110 are not paired by a common extension member 143, but individually and separately paired to a common point(s) (such as, e.g., by pin 141) in the swivel connector 122, the legs 106, 110 may be individually and independently moved along the direction B to reconfigure the table 100 from the extended configuration (shown in FIG. 5) to the operative configuration (shown in FIG. 6).

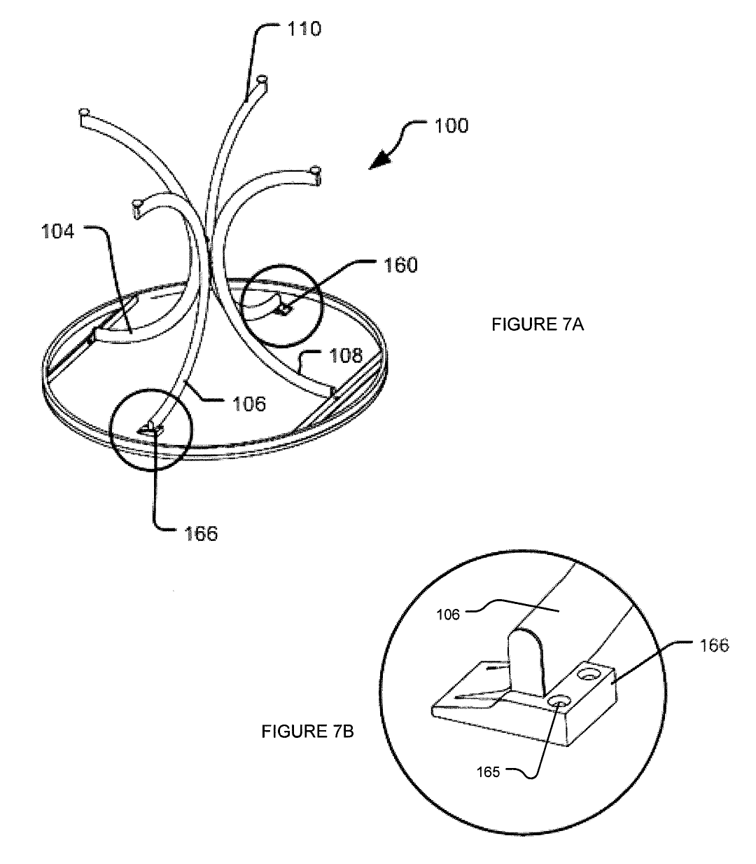

FIG. 7A shows an example of a bottom side view of the table 100 in an operative configuration with the legs 106, 110 coupled to couplers 166, 160, respectively.

FIG. 7B shows an exploded view of an example of the leg 106 coupled to the coupler 166. The coupler 166 may include one or more holes or recesses 165 that are configured to receive, for example, a screw, a nail, or the like, to affix the coupler 166 to the bottom side of the table 100. Alternatively (or additionally), the coupler 166 may be affixed to the bottom side of the table 100 by means of an adhesive, such as, for example, but not limited to, glue, Velcro™, rubber cement, or the like. The leg 106 may be snapped into a coupled position (shown in FIG. 7B) by a tongue-groove pairing (not shown) with the coupler 166. That is, the leg 106 may include a tongue (or groove) (not shown) at its end portion that couples to the coupler 166; and the coupler 166 may include a groove (or tongue) (not shown) configured to mate with the tongue (or groove) on the end portion of the leg 106.

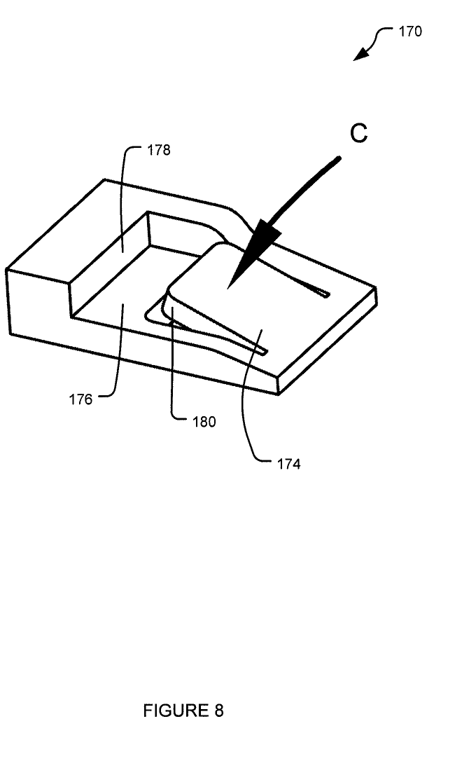

FIG. 8 shows an example of a preferred embodiment of the coupler 166 (or 160) according to principles of the invention. As seen, the coupler 166 (or 160) may include a locking ramp 170, as seen in FIG. 8. The locking ramp 170 may include an elastic member 174 which may be depressed in the direction of an arrow C when a leg is inserted or moved across the surface of the elastic member 174. The locking ramp 170 may also include a seat portion 176. An end portion of a respective leg 106 (or 110) may be moved across the elastic member 174, forcing the same downwardly as it moves across the surface of the elastic member 174, stopping in the seat portion 176. The coupler 166 may include a stop 178, which may stop and hold the end portion of the leg 106 in the seat portion 176. Once the end portion of the leg 106 is positioned in the seat portion 176, the elastic member 174 may extend back (opposite the direction of arrow C) and hold the end portion of the leg 106 in the seat portion 176 due to a surface 180 of the elastic member 174. The elastic member 174 may be configured to provide, for example, but is not limited to, five-pounds-per-square-inch of resistance force. That is, it may require a force of 5 lbs/in² of force in the direction C to cause the elastic member 174 to be fully depressed. It is noted that the elastic member 174 may be configured to provide less, or more than five-pounds-per-square-inch of resistance force, such as, for example, 2, 3, 4, 8, 9, 10, 12 lbs/in², or more. To move (or depress) the elastic member 174, so that the end portion of the leg 106 may move, a force greater than the resistance force may be applied to the elastic member 174 in the direction C, such as, for example, by hand. The released leg 106 may then swivel and the table 100 may be placed in the compact configuration.

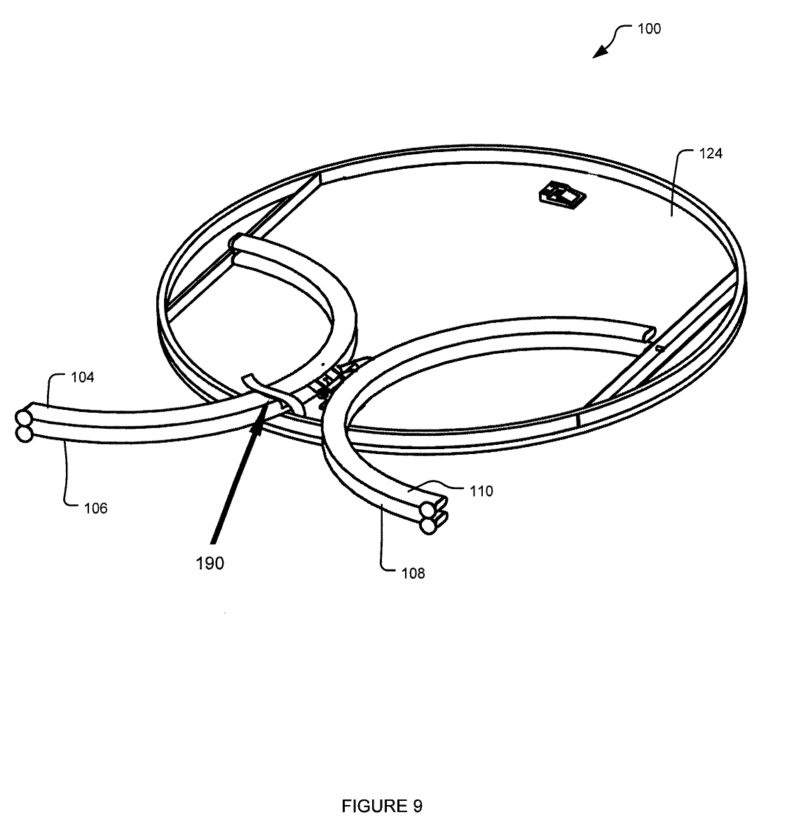

FIG. 9 shows a bottom view of the table 100 with the legs 104, 106, 108, 110 arranged in the compact and locked configuration, including a lock 190 to maintain the legs in the compact configuration, according to principles of the invention. The lock 190 may be configured to hold at least one of the legs 104, 106, 108,110 in a position substantially proximate to (or against) the table bottom 124, so that during storage or transport of the table 100, the legs may be held in the compact and locked configuration and prevented from moving or rotating. In one aspect, the lock 190 may include a hook and loop type mechanism secured to the table bottom 124. The lock 190 may be configured to swivel or pivot in a plane substantially normal to the surface of the table bottom 124, such that the lock 190 pivots from an open position to a closed (or locked) position (shown in FIG. 9), or visa-a-versa. For example, the loose end(s) of the lock 190 may extend around one or more of the legs 104, 106, 108, 110 and then pivot about the one or more legs as the legs are moved to the compact configuration, securing the legs close to the table bottom 124.

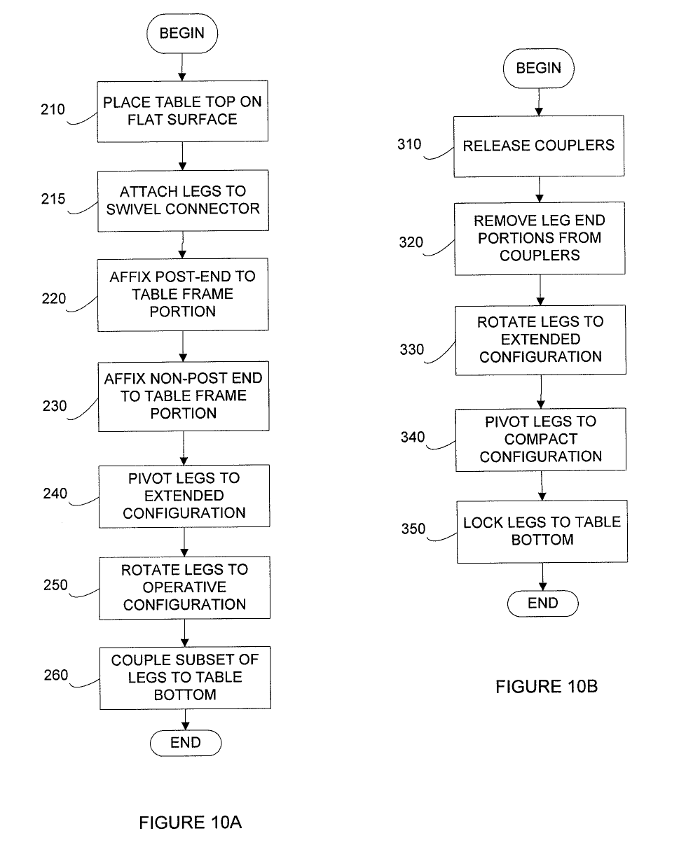

FIG. 10A shows a flow diagram of an example of a process for assembling and affixing a plurality of legs to a table bottom and moving the legs to the compact configuration, according the principles of the invention. Referring to FIGS. 2A, 2B, 3A, 3B and 10A, the table top may be placed on a flat surface, so that the table bottom and table frame portion(s) 126 are visible and accessible (Step 210). A portion of each of the legs 104, 106, 108, 110 may be connected to a swivel connector 122 (Step 215). A leg end portion having a pivotal connector 130 (shown in FIG. 3A) of the leg 108 may be inserted into a hole 128 in the table frame portion 126 (Step 220) (shown in FIG. 3B). The process may be repeated for each leg end portion that has a pivotal connector 130. The pivotal fastener 144 (shown in FIG. 2B) may affix a portion of the opposite leg 104 (i.e., opposite leg 108) to the table frame portion 126 using, e.g. the nut 145 and bolt 147 combination, to allow the end portion of the leg 104 to pivot (Step 230). The process may be repeated for each leg to be coupled to the bottom surface using a pivotal fastener 144.

After the legs 104, 108 are pivotally attached to the table frame portions (Steps 220, 230), the legs 104, 106, 108, 110 may be pivoted along the direction A (shown in FIG. 5) to move the legs into the extended configuration (Step 240). Then, the unattached legs 106, 110 may be simultaneously (or individually) swiveled (or rotated) along the direction B (shown in FIG. 6) to move the legs into the operative configuration (Step 250). Thereafter, as shown in FIG. 7B, end portions of the legs 106, 110 may be inserted into the couplers 160, 166 to securely and firmly hold the legs 106, 110 in the operative configuration (Step 260).

FIG. 10B shows a flow diagram of an example of a process for releasing and configuring the table 100 into a compact and locked configuration. Referring to the Figures, each of the couplers 160, 166 (shown in FIG. 7A) may be operated to release the end portions of the legs 110, 106, respectively (Step 310). For example, where the couplers 160, 166 include the locking ramp 170, the elastic member 174 of each of the couplers 160, 166 may be depressed by a finger in the direction C to release the end portion of each respective leg 110, 106. The end portions of the legs 110, 106 may then be removed from the seat portions 176 (shown in FIG. 8) (Step 320). The uncoupled legs 110, 106 may be simultaneously (or individually) rotated in the direction opposite to direction B to the extended configuration (shown in FIG. 5) (Step 330). The legs 104, 106, 108, 110 may be pivoted in the direction opposite to the direction A (shown in FIG. 5) to the compact configuration (Step 340). One or more of the legs 104, 106, 108, 110 may be locked to the table bottom to secure the legs 104, 106, 108, 110 in the compact configuration (Step 350).

The invention provides for a very strong table with attractive legs that are sturdy and that has the ability to be easily rearranged in a compact arrangement for transportation or storage.

It is noted that the legs 104, 106, 108, 110 may have a semicircular shape. This shape is well-suited for providing stability with an increased footprint size of the table. This shape allows for the use of the swivel connector 122 to be arranged under the table, increases leg room, and further allows for increased stability of the table. However, other leg constructions are contemplated by the invention that provide similar results with the folding and swivel concepts described herein.

Additionally, it is noted that the legs 104, 106, 108, 110 are connected to table frame portions 126, however the invention may also be achieved by connecting the legs 106 and 108 with other types of mechanical fasteners directly to the table bottom 124 without the inclusion of the table frame portions 126.

It is noted that the parts of the table, including the table top 120, legs 104, 106, 108, 110, swivel connector 122, table frame portions 126, posts 130, and the like, may include, for example, but are not limited to, wood materials, plastic materials, metal materials, composite materials, and/or the like.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A reconfigurable table including a table top having a top surface and a bottom surface, the table comprising:
a plurality of legs configured to support the table top, wherein the plurality of legs comprises a swivel leg and a pivoting leg;
a swivel connector configured to connect the swivel leg to the pivoting leg, wherein the swivel connector is further configured to allow the swivel leg to swivel with respect to the pivoting leg; and
a pivotal connector configured to pivotally connect the pivoting leg to the bottom surface,
wherein the swivel leg is only connected to the swivel connector when the plurality of legs are arranged in a compact configuration.

2. A reconfigurable table including a table top having a top surface and a bottom surface, the table comprising:
a plurality of legs configured to support the table top, wherein the plurality of legs comprises a swivel leg and a pivoting leg;
a swivel connector configured to connect the plurality of legs to each other along a first axis, wherein the swivel connector is further configured to allow at least one of the plurality of legs to rotate in a plane substantially perpendicular to the first axis; and
a pivotal connector configured to pivotally connect the pivoting leg to the bottom surface.

3. The table according to claim 2, wherein at least one of the plurality of legs comprises a curved shape that is configured to extend from an upper end at an outer edge of the bottom surface inwardly to the swivel connector and extend outwardly from the swivel connector to a floor.

4. The table according to claim 2, further comprising:
a table frame portion attached to the bottom surface.

5. The table according to claim 4, wherein the table frame portion is configured to be coupled to the pivotal connector.

6. The table according to claim 2, wherein the swivel leg is configured to swivel with respect to the pivoting leg.

7. The table according to claim 2, wherein the swivel leg is positioned substantially opposite the pivoting leg when the plurality of legs is arranged in an operative configuration.

8. The table according to claim 2, further comprising:
a coupler configured to receive a portion of the swivel leg.

9. The table according to claim 8, wherein the coupler comprises:
a locking ramp configured to receive the portion of the swivel leg.

10. The table according to claim 8, wherein the coupler comprises:
an elastic member configured to move in response to a predetermined force;
a seat portion configured to receive the portion of the swivel leg; and
a stop configured hold the portion of the swivel leg in the seat portion.

11. The table according to claim 5, wherein the pivotal connector comprises:
a post configured to be inserted into the table frame portion.

12. The table according to claim 11, wherein the post is arranged on an end portion of the pivoting leg.

13. The table according to claim 4, further comprising:
a pivotal fastener configured to attach another pivoting leg to the bottom surface.

14. The table according to claim 13, wherein the pivotal fastener comprises a bolt and nut combination.

15. The table according to claim 2, further comprising:
a lock configured to hold at least one of the plurality of legs in a position substantially parallel to the bottom surface.

16. The table according to claim 15, wherein the lock comprises:
a hook and loop mechanism secured to the bottom surface.

17. A method for configuring a reconfigurable table that includes a table top having a top surface and a bottom surface, the method comprising:
coupling a pivoting leg to the bottom surface;
affixing another pivoting leg to the bottom surface; and
attaching the pivoting legs to each other, wherein the pivoting legs pivot substantially simultaneously with respect to the bottom surface.

18. The method according to claim 17, further comprising:
attaching opposing swivel legs to the pivoting legs, wherein the opposing swivel legs swivel with respect to the pivoting legs.

19. The method according to claim 17, wherein the coupling the pivoting leg to the bottom surface comprises inserting a post into a table frame portion.

20. The method according to claim 17, wherein the affixing the another pivoting leg comprises attaching the another pivoting leg to a table frame portion with a bolt and nut combination.

21. The method according to claim 18, further comprising:
attaching a lock to the bottom surface, wherein the lock is configured to hold at least one of the pivoting legs and swivel legs.
